(19) United States
(12) Patent Application Publication
(10) Pub. No.: US 2024/0289656 A1
(43) Pub. Date: Aug. 29, 2024

(54) CONSTRUCTION OF DOMAIN-SPECIFIC CAUSAL RELATIONS

(71) Applicant: International Business Machines Corporation, Armonk, NY (US)

(72) Inventor: Naoto Sato, Kawasaki-shi (JP)

(21) Appl. No.: 18/175,608

(22) Filed: Feb. 28, 2023

(51) Int. Cl. G06N 5/047

(52) U.S. Cl. CPC G06N 5/047

(57) ABSTRACT

A method of determining causal relations includes receiving a set of events, a selected event and a request to determine whether the set of events has a causal relation with the selected event, receiving a causality collection including a plurality of causality pairs, and receiving an entailment collection including a plurality of entailment pairs, each entailment pair including a first event and a second event. A first group of events is selected from the causality and entailment collections, and the first group of events is formulated as a first domain-specific algebraic structure. The method further includes selecting a second group of events from the causality and entailment collections, formulating the second group of events as a second domain-specific algebraic structure, and determining a causal relation between the set of events and the selected event based on a relation between the first structure and the second structure.

### BACKGROUND

The present invention relates generally to programmable computers, and more specifically to computing systems configured and arranged to construct or determine causal relations between phenomena.

Determination of causal relations is useful in many contexts, and can become more challenging as the amount of data collected increases. Such determinations can be resource intensive and may entail manual analysis to accurately detect relationships between causes and effects that are not readily discernable.

### SUMMARY

Embodiments of the invention are directed to a computer-implemented method of determining causal relations. The method includes receiving, by a processor, a set of events, a selected event and a request to determine whether the set of events has a causal relation with the selected event, and receiving a causality collection including a plurality of causality pairs, each causality pair including a cause event and an effect event. The method also includes receiving an entailment collection including a plurality of entailment pairs, each entailment pair including a first event and a second event, the first event logically entailing the second event, selecting a first group of events from the causality collection and the entailment collection, the first group of events associated with a first domain, and formulating the first group of events as a first domain-specific algebraic structure. The method further includes selecting a second group of events from the causality collection and the entailment collection, the second group of events associated with a second domain, formulating the second group of events as a second domain-specific algebraic structure, and determining a causal relation between the set of events and the selected event based on a relation between the first structure and the second structure.

Other embodiments of the invention implement features of the above-described method in computer systems and computer program products.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a computer system capable of implementing embodiments of the invention described herein;

FIG. 2 depicts a block diagram illustrating a method of determining causal relations, in accordance with an embodiment of the invention;

FIG. 3 depicts an example of an algebraic space including algebraic structures used in the method of FIG. 2;

FIG. 4 depicts the algebraic space of FIG. 3 and an example of causal reasoning used to determine whether a set of events is causally related to a selected event; and

FIG. 5 depicts a computing environment according to one or more embodiments of the invention.

In the accompanying figures and following detailed description of the disclosed embodiments, the various elements illustrated in the figures are provided with two or three digit reference numbers, where appropriate.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Systems, methods and devices are provided for analyzing collected data and determining causal relationship between events or phenomena from the collected data. Embodiments of the invention include a method includes receiving examples of cause-effect relations in the form of a plurality of pairs of domain-specific cause-effect data, each pair including a statement or other indication of a causal phenomenon or event (i.e., a cause) and a statement or other indication of an effect of the causal phenomenon (i.e., an effect). The method may also include receiving examples of domain-specific entailment data (e.g., entailment pairs indicating that a given event entails another event)

The method includes formulating events from the cause-effect data (also referred to as a “causality collection”) and the entailment data (also referred to as an “entailment collection”) as algebraic structures such as distributive lattices. The algebraic structures are related or mapped to each other, for example, by determining a homomorphism between the structures, and a set of causal relations are derived that retains the homomorphism. The mapping or homomorphism may be determined by causal reasoning or formal concept analysis. Embodiments of the invention thus provide a process to automatically generate causal relations from a relatively small number of examples (i.e., a subset of a collection of cause-effect data) and ensuring the correctness of the generated relations by formal means.

Embodiments of the invention described herein present a number of advantages and technical effects. The methods provide for an accurate and efficient way to infer causal relationships of phenomena, and address various problems associated therewith. For example, causal relations can be difficult to define and maintain manually, as such relations may be domain-specific and not always consistent. In addition, the reasoning as discussed herein is based on both causal reasoning and entailment reasoning to provide more accurate descriptions of causal relations between phenomena.

The methods provide a solution in the form of an automated procedure for constructing causal relations, which does not require labor intensive manual analysis. In addition, the methods described herein can be used to derive causal relationships in more time and cost-efficient manner than existing techniques. For example, the embodiments of the invention provide for automatic determination of causal relationship using a relatively low number of examples without substantially reducing accuracy, thereby reducing the amount of time and computing resources needed for various data analyses.

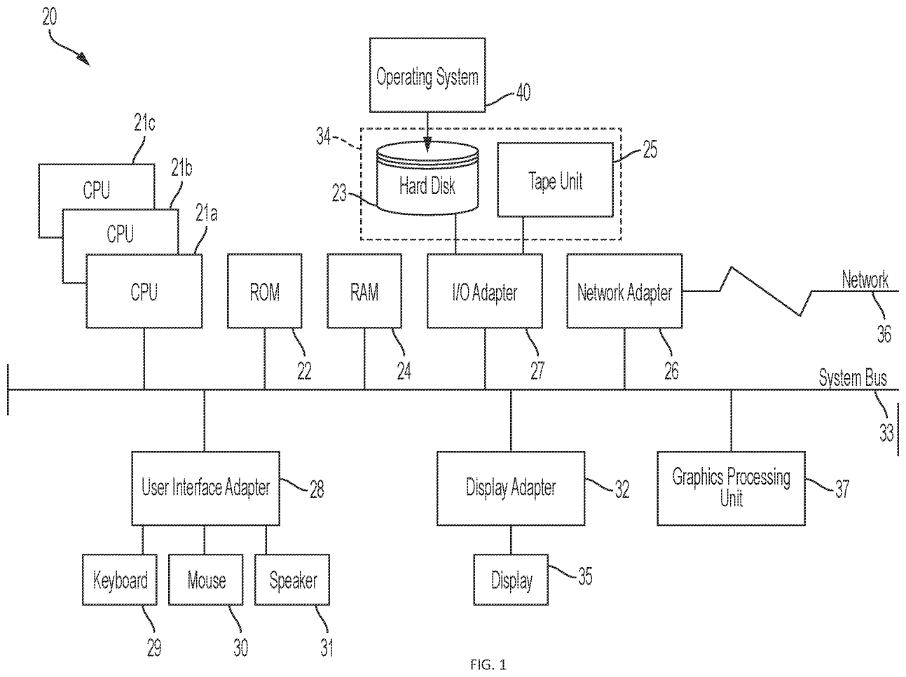

FIG. 1 illustrates a block diagram of a processing system 20 for implementing the techniques described herein. In examples, processing system 20 has one or more central processing units (processors) 21a, 21b, 21c, etc. (collectively or generically referred to as processor(s) 21). In aspects of the present disclosure, each processor 21 may include a reduced instruction set computer (RISC) microprocessor. Processors 21 are coupled to system memory (e.g., random access memory (RAM) 114) and various other components via a system bus 33. Read only memory (ROM) 22 is coupled to system bus 33 and may include a basic input/output system (BIOS), which controls certain basic functions of processing system 20.

Further illustrated are an input/output (I/O) adapter 27 and a communications adapter 26 coupled to system bus 33. I/O adapter 27 may be a small computer system interface (SCSI) adapter that communicates with a hard disk 23 and/or a tape storage drive 25 or any other similar component. I/O adapter 27, hard disk 23, and tape storage device 25 are collectively referred to herein as mass storage 34. Operating system 40 for execution on processing system 20 may be stored in mass storage 34. A network adapter 26 interconnects system bus 33 with an outside network 36 enabling processing system 20 to communicate with other such systems.

A display (e.g., a display monitor) 35 is connected to system bus 113 by display adaptor 32, which may include a graphics adapter to improve the performance of graphics intensive applications and a video controller. In one aspect of the present disclosure, adapters 26, 27, and/or 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 may be interconnected to system bus 33 via user interface adapter 28, which may include, for example, a Super I/O chip integrating multiple device adapters into a single integrated circuit. The system 20 may include other processing devices, such as one or more graphics processing units (GPUs) 37.

Thus, as configured herein, processing system 20 includes processing capability in the form of processors 21, storage capability including system memory (e.g., RAM 24), and mass storage 34, input means such as keyboard 29 and mouse 30, and output capability including speaker 31 and display 35. In some aspects of the present disclosure, a portion of system memory (e.g., RAM 24) and mass storage 34 collectively store an operating system such as the AIX® operating system from IBM Corporation to coordinate the functions of the various components shown in processing system 20.

As noted above, causation is algebraically constructed in order to determine causal relations from a set of examples. In an embodiment of the invention, the algebraic construction and other aspects of embodiments of the invention are based on formal concept analysis. Formal concept analysis is a method of determining hierarchies of concepts, in which each concept represents a set of objects (e.g., actions or effects) that share one or more common properties.

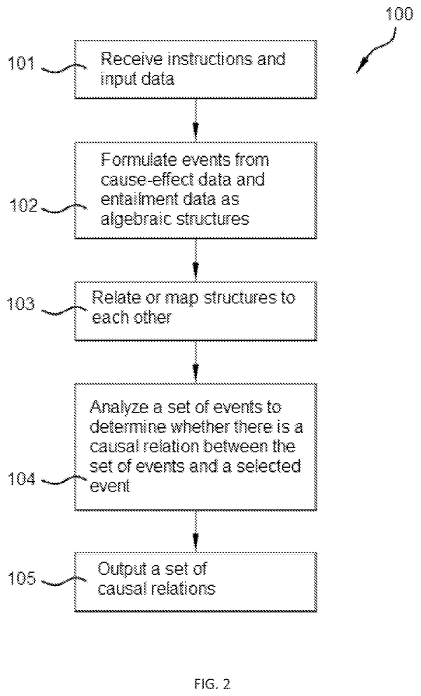

FIG. 2 illustrates a flow diagram of a computer-implemented method 100 for determining or constructing causal relations. Aspects of the method 100 are discussed as being performed by the computer system 20 and/or one or more CPUs 21, but may be performed by any suitable processing device or system. In addition, the method 100 can be performed across any system, including cloud computing networks and other networks.

The method 100 includes a number of steps or stages represented by blocks 101-105. The method 100 is not limited to the number or order of steps therein, as some steps represented by blocks 101-105 may be performed in a different order than that described below, or fewer than all of the steps may be performed.

At block 101, the processor receives an instruction and a set of input data. The set of input data includes a plurality of data pairs, in which each data pair represents an example of a relation between various phenomena (e.g., statement, fact, action, function, etc.), also referred to as “events.” An event may correspond to any data value or statement.

In an embodiment of the invention, the input data includes one or more events ϕᵢ, represented as a set of events Φ={ϕ₁, ϕ2 . . . ϕₙ}, where ϕᵢ of is an event having an index i, and n is the number of events in the set. In addition, an event ψ (referred to as a “selected event”) is provided, and the instruction includes a request to determine whether any causal relations exist between the set of events Φ (i.e., one or more of the events ϕᵢ) and the selected event ψ (i.e., is an event or events in the set Φ highly likely to be a cause of the event ψ).

In an embodiment of the invention, the input data includes a collection (e.g., database) of causality pairs DB_{C} and entailment pairs DB_{E}. As described herein, “causality” refers to a relation between events, where one event (a “cause event”) is highly likely to cause another event (an “effect event”). “Entailment” is a relation where one event (a “first event”) is logically certain to cause another event (a “second event”), or logically entails another event. As entailment and causality are related concepts, but not necessarily equivalent, the distinction between entailment and causality is subtle and can lead to confusion. The method 100 addresses this limitation by addressing causality and entailment differently and as distinct relations.

Causality, or a causal relation between an event ϕ (cause) and an event ψ (effect), may be defined as the event ψ being highly likely to occur as a result of the event ϕ occurring. An event ϕ may be considered a causal event if the event ϕ is consecutive to the event ψ (i.e., without interceding events in a data set), occurs before the event ψ, and it is recognized that the event ϕ is the primary reason that the event y occurs subsequently.

Causality typically has an uncertainty associated therewith (“ϕ may cause ψ”), whereas entailment does not have such uncertainty (“ϕ logically entails ψ”). In an embodiment of the invention, an event ϕ is considered to entail an event ψ when ϕ occurs at a certain time point or moment T, and it is certain that that ψ is occurring at T as well.

For a given set of events Φ={ϕ₁, ϕ₂ . . . ϕₙ}, and a selected event ψ, “Φ [symbol] ψ” denotes that events in the set Φ entail ψ. “Φ [symbol] _{C}ψ” denotes that the set Φ causes ψ (or events in Φ may eventually cause ψ).

It is helpful to consider the amount of time ΔT that passes between φ and ψ, and the degree of uncertainty on the likelihood that ψ follows φ. In many cases, the longer time passes and/or the higher uncertainty rises, the more likely the pair gets recognized as a causal event pair.

Each set of entailment pairs DB_{E} and causality pairs DB_{C} includes at least one pair of events {ϕ, ϕ}. The following is a description of an example of input data, which is provided for illustration purposes to describe the method 100. It is noted that this example is not intended to limit the types of information that can be used as input data.

In this example, the set of events Φ includes an economic recovery event (“recover(economy)”) and a disruption in a fuel supply (“disrupt(supply(fuel))”), and the event ψ is a risk of inflation (“risk(inflation)”). Φ and ψ can be represented as:
Φ={recover(economy)¹, disrupt(supply(fuel)²}, and
ψ=risk(inflation)+⁴².

Also in this example, the set of causality pairs and the set of entailment pairs include the following:
DB_{C}={(recover(economy)¹, rise(demand(fuel))³¹), (disrupt(supply(fuel)², drop(supply(fuel)³²), ((rise(demand(fuel))∧disrupt(supply(fuel)))³³, rise(price(fuel)⁴¹)}; and
DB_{E}={rise(price(fuel)⁴¹, risk(inflation)⁴²}.

The superscripts are provided as identifiers of each event and are used in explanation of subsequent stages of the method 100. An event having a superscript identifier s (i.e., ϕ^{s}) is also referred to as “es”. For example, the event “recover(economy)¹” is also denoted as “e1”.

At block 102, each event (excluding events in the set Φ) from DB_{C} and DB_{E} is categorized or associated with a given domain, and events categorized as being in a given domain are formulated into a domain-specific algebraic structure. Thus, each event in a given structure is similar in that each event belongs to some degree to the same domain.

In an embodiment of the invention, the events are formulated such that events in the same structure (e.g., lattice or other algebraic structure) are not causally related. Events in the same structure may be related in terms of entailment, and events from different structures may be related in terms of causality.

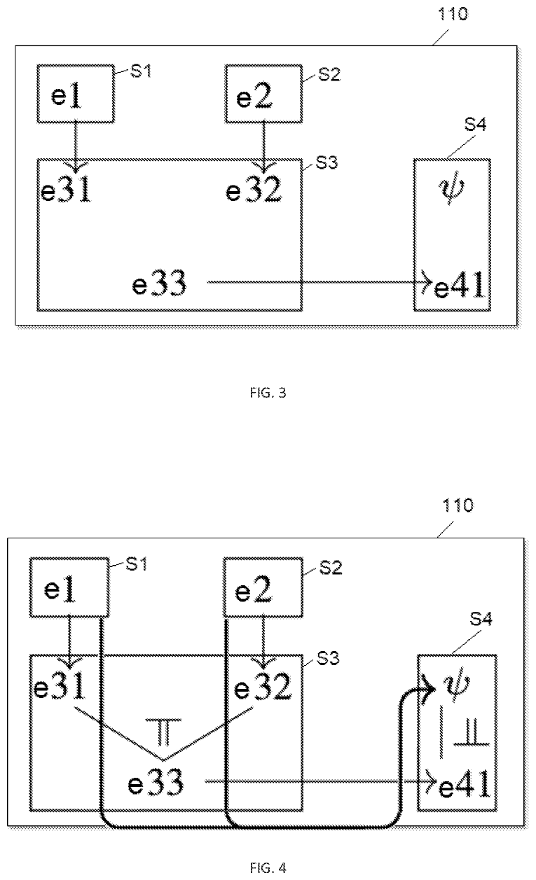

For example, referring to FIG. 3, the events from DB_{C} and DB_{E} are assigned to different domain spaces or structures in an algebraic space 110. Event e1 is formulated in a structure S1 and event e2 is formulated as a structure S2. Events e31, e32 and e33 are similar in that they are in a domain that corresponds to fuel supply and demand, and thus these events are assigned to a structure S3 (a fuel supply/demand space). Event 41 relates to fuel price, and is assigned to a structure S4 (a fuel price space). Lastly, the event e42, which is the selected event w, is assigned to the structure S4, as it is in a domain that corresponds to fuel price.

At block 103, the algebraic structures defined at block 102 are related or mapped to each other. In an embodiment of the invention, at least one causal pair is used to generate the relation or mapping.

At block 104, each event in the set of events Φ is logically analyzed (e.g., by causal reasoning) to determine whether the set of events Φ has a causal relation to the event ψ, i.e., whether Φ may cause ψ or is likely to cause ψ (thus Φ [symbol] _{C}ψ holds).

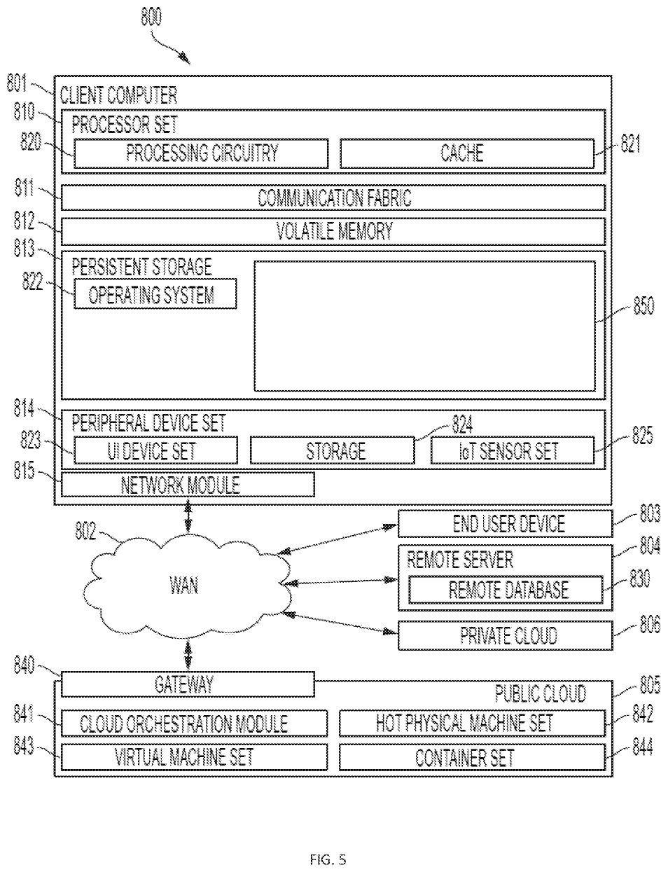

At block 105, a set of causal relations is output, which indicates whether there is a causal relation and identifies which event(s) in the set of events Φ is/are causally related to the selected event ψ. The output may also include an explanation of the relations. For example, the explanation details the logical process by which an event was identified as being causally related to the selected event, which may be a textual or graphical explanation. For example, a description of one or more causal reasoning steps or a graphic similar to the illustration shown in FIG. 4 may be provided to a user to assist the user in understanding the various relationships between events.

In an embodiment of the invention, in case Φ [symbol] _{C}ψ holds, the output indicates that there is a causal relation (e.g., says “YES”) and explains how the causal relation occurs.

The explanation can include both casual relations Fc and entailment relations F. In case Φ [symbol] _{C}ψ does not hold, the output indicates that a causal relation was not found (e.g., says “NO”).

In an embodiment of the invention, causal relations are determined (e.g., at block 105) recursively using the following reasoning steps (denoted as steps R1-R4):

$$\{ ϕ , … \} {≦}_{C} ψ when ∃ f ∈ ℱ s . t . f ( ϕ ) = ψ ; \qquad ( R1 )$$

$$\frac{Φ ≦ ϕ Φ ⋃ \{ ϕ \} {≦}_{C} ψ}{Φ {≦}_{C} ψ} when ϕ , ψ ∈ {}^{∃} E ∈ ℰ ; \qquad ( R2 )$$

$$\frac{Φ {≦}_{C} ψ Φ ⋃ \{ ψ \} ≦ {ψ}^{′}}{Φ {≦}_{C} {ψ}^{′}} when ψ , {ψ}^{′} ∈ {}^{∃} E ∈ ℰ ; \qquad ( R3 )$$

$$and \frac{Φ {≦}_{C} {ϕ}_{i} ( i = 1 , 2 , … ) Φ ⋃ \{ {ϕ}_{1} , {ϕ}_{2} , … \} {≦}_{C} ψ}{Φ {≦}_{C} ψ} \qquad ( R4 )$$

$$when {ϕ}_{1} , {ϕ}_{2} , … ∈ {}^{∃} E ∈ ℰ .$$

In the above, E is a set of events and an element of a partition of the set of events, and ε is a partition of the set of events. If the above statements are true for a selected event ψ, the selected event is considered to be causally related to the events in a set Φ.

FIG. 4 illustrates the use of the above causal reasoning steps in the example of FIG. 3. In this example, e1 and d2 are assumed to occur (step R1), and since e1 causes e31 and e2 causes e32, both e31 and e32 both occur as a result of e1 and e2. Because e32 occurs and e32 causes e33, e33 occurs, and hence e33 causes e41 and e41 occurs. As e41 entails e42 (the selected event ψ), e42 occurs and the set Φ is considered to have a causal relation with the selected event ψ.

In an embodiment of the invention, causation is formulated algebraically by constructing the spaces as algebraic lattices of events in the causal pairs and entailment pairs, and determining a homomorphism between the lattices.

A “lattice” is a partially ordered set (poset) in which each two-element subset (a,b) has a “join” (defined as a least upper bound, denoted by aVb)a meet (defined as a greatest lower bound, denoted by a∧b). Homomorphism is a structure-preserving mapping between two algebraic structures (e.g., two lattices). For sets of causes and effects, a homomorphism captures similar causes that relate to similar effects. In an embodiment of the invention, the lattices and homomorphism are determined using formal concept analysis. In the above example, the cause-effect relation between e33 and e41 induces a homomorphism between the two structures.

For example, a lattice, denoted as (Φ, ≤), is a partially ordered set of logical propositions where an event ϕ₁ is ordered with an event ϕ₂ (ϕ₁≤θ₂) if and only if (“iff”) ϕ₁→ϕ₂ is valid (i.e., [symbol] ϕ₁→ϕ₂). This yields a Boolean algebra or Boolean lattice, where the meet is defined by logical conjunction and the join is defined by logical disjunction.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 5 depicts an example computing environment 800 that can be used to implement aspects of the invention. Computing environment 800 contains an example of an environment for the execution of at least some of the computer code involved in performing the inventive methods, such as new personalized and context-aware explanation format generation code 850. In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method of determining causal relations, the computer-implemented method comprising:
receiving, by a processor, a set of events, a selected event, and a request to determine whether the set of events has a causal relation with the selected event;
receiving a causality collection including a plurality of causality pairs, each causality pair including a cause event and an effect event;
receiving an entailment collection including a plurality of entailment pairs, each entailment pair including a first event and a second event, the first event logically entailing the second event;
selecting a first group of events from the causality collection and the entailment collection, the first group of events associated with a first domain;
formulating the first group of events as a first domain-specific algebraic structure;
selecting a second group of events from the causality collection and the entailment collection, the second group of events associated with a second domain;
formulating the second group of events as a second domain-specific algebraic structure; and
determining a causal relation between the set of events and the selected event based on a relation between the first structure and the second structure.

2. The method of claim 1, wherein determining the causal relation includes mapping the first algebraic structure to the second algebraic structure.

3. The method of claim 2, wherein the mapping is based on a relation between an event in the first structure and an event in the second structure, the causal relation defined by a causal pair or an entailment pair.

4. The method of claim 1, wherein the set of causality pairs includes the set of events, and the set of entailment pairs includes the additional event.

5. The method of claim 1, wherein events in the first structure are not causally related, and events in the second structure are not causally related.

6. The method of claim 2, wherein the mapping and determining the causal relation is performed using formal concept analysis.

7. The method of claim 6, wherein causal relations are defined by a homomorphism between the first structure and the second structure.

8. The method of claim 6, wherein the first structure and the second structure are algebraic lattices.

9. A computer system for determining causal relations, the computer system comprising a memory communicatively coupled to a processor, where the processor is configured to perform operations comprising:
receiving a set of events, a selected event, and a request to determine whether the set of events has a causal relation with the selected event;
receiving a causality collection including a plurality of causality pairs, each causality pair including a cause event and an effect event;
receiving an entailment collection including a plurality of entailment pairs, each entailment pair including a first event and a second event, the first event logically entailing the second event;
selecting a first group of events from the causality collection and the entailment collection, the first group of events associated with a first domain;
formulating the first group of events as a first domain-specific algebraic structure;
selecting a second group of events from the causality collection and the entailment collection, the second group of events associated with a second domain;
formulating the second group of events as a second domain-specific algebraic structure; and
determining a causal relation between the set of events and the selected event based on a relation between the first structure and the second structure.

10. The computer system of claim 9, wherein determining the causal relation includes mapping the first algebraic structure to the second algebraic structure.

11. The computer system of claim 10, wherein the mapping is based on a relation between an event in the first structure and an event in the second structure, the relation defined by a causal pair or an entailment pair.

12. The computer system of claim 9, wherein the set of causality pairs includes the set of events, and the set of entailment pairs includes the additional event.

13. The computer system of claim 9, wherein events in the first structure are not causally related, and events in the second structure are not causally related.

14. The computer system of claim 10, wherein the mapping and determining the causal relation is performed using formal concept analysis, and the causal relation is defined by a homomorphism between the first structure and the second structure.

15. The computer system of claim 14, wherein the first structure and the second structure are algebraic lattices.

16. A computer program product for determining causal relations, the computer program product comprising a computer readable storage medium having program instructions embodied therewith, the program instructions executable by a processor system to cause the processor system to perform operations comprising:
receiving a set of events, a selected event, and a request to determine whether the set of events has a causal relation with the selected event;
receiving a causality collection including a plurality of causality pairs, each causality pair including a cause event and an effect event;
receiving an entailment collection including a plurality of entailment pairs, each entailment pair including a first event and a second event, the first event logically entailing the second event;
selecting a first group of events from the causality collection and the entailment collection, the first group of events associated with a first domain;
formulating the first group of events as a first domain-specific algebraic structure;
selecting a second group of events from the causality collection and the entailment collection, the second group of events associated with a second domain;
formulating the second group of events as a second domain-specific algebraic structure; and
determining a causal relation between the set of events and the selected event based on a relation between the first structure and the second structure.

17. The computer program product of claim 16, wherein determining the causal relation includes mapping the first algebraic structure to the second algebraic structure.

18. The computer program product of claim 17, wherein the mapping is based on a relation between an event in the first structure and an event in the second structure, the relation defined by a causal pair or an entailment pair.

19. The computer program product of claim 16, wherein:
the set of causality pairs includes the set of events;
the set of entailment pairs includes the additional event;
events in the first structure are not causally related; and
events in the second structure are not causally related.

20. The computer program product of claim 17, wherein the mapping and determining the causal relation is performed using formal concept analysis, the causal relation is defined by a homomorphism between the first structure and the second structure, and the first structure and the second structure are algebraic lattices.
